(19) United States
(12) Patent Application Publication
(10) Pub. No.: US 2026/0041286 A1
(43) Pub. Date: Feb. 12, 2026

(54) SYSTEM AND DEVICE FOR ORGANIZING MULTIPLE DOSES OF POWDERED PRODUCT

(71) Applicant: ISAAC CHRISTIAN, Grants Pass, OR (US)

(72) Inventor: ISAAC CHRISTIAN, Grants Pass, OR (US)

(21) Appl. No.: 19/291,409

(22) Filed: Aug. 5, 2025

Related U.S. Application Data
(60) Provisional application No. 63/679,969, filed on Aug. 6, 2024.

(51) Int. Cl. A47J 47/01; B65D 83/06

(52) U.S. Cl. CPC A47J 47/01; B65D 83/06

(57) ABSTRACT

A device and system for organizing and filling multiple individual containers with powdered or other flowable products are provided. The device comprises a receptacle ring defining a plurality of circumferentially spaced slots configured to receive and suspend individual containers above a base. A vertical support extends between the base and the receptacle ring and further supports a rotating dispenser platform positioned above the receptacle ring. A dispenser, such as a funnel, may be defined by or engaged with an opening defined by the rotating platform such that, upon rotation, the dispenser aligns sequentially with each receptacle slot to efficiently and hygienically fill each container.

### CROSS-REFERENCE TO RELATED APPLICATIONS

This application claims benefits of U.S. Patent Application No. 63/679,969 filed Aug. 6, 2024, which is incorporated herein by reference.

### GOVERNMENT CONTRACT

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to dosage separators and organizers for food, drink, ingredients, supplies, medication and/or supplements and, more particularly, to a dosage separator and organizer for powdered supplements.

### BACKGROUND

Powdered food and nutritional supplements have grown increasingly popular in recent years due, in part, to marketing efforts and shifting consumer trends that have heightened awareness regarding their use and availability to address a diverse array of health, wellness, and lifestyle concerns. As such, there is a wide variety of powdered supplements available, including, for example, vitamins, minerals, protein powders, collagen, amino acid powders, electrolytes, and many others, all catering to different health, wellness, and fitness goals. Many supplements are formulated to target specific issues or concerns, and indeed, some ingredients may be contraindicated for different purposes. As a result, some individuals dose multiple powdered supplements mixed into meals or drinks throughout their day for different purposes. For example, it would not be unheard of for someone to take a plant based “greens” powder supplement in the morning to ensure that they consume their daily vitamins and minerals, activate their digestive system, and provide a bit of energy; a collagen powder in a meal-time smoothie to improve skin hydration and elasticity; a “pre-workout” powder comprising caffeine, carbohydrates and electrolytes to improve energy levels and performance during a workout; a post workout powder containing protein, creatine, and amino acids that aid in the biosynthesis of proteins; and even a bedtime supplement having melatonin and magnesium to aid sleep, cognition and muscle function.

Others may take fewer supplements throughout the day, but are committed to taking those that they do on a regular, sometimes daily, basis. This principle similarly applies to infant formula, where caregivers may be tasked with ensuring a selected formula powder is administered regularly in appropriate amounts to meet the infant's nutritional needs.

Still others may be responsible for preparing and dispensing powdered doses for multiple people-such as infants, children, clients, or patients-rather than just managing their own use. This creates a greater need for organized and efficient systems that can help minimize spillage, reduce dosing errors, reduce preparation time, and support consistency in daily routines.

Unfortunately, powdered food products, such as powdered supplements, are not particularly space efficient. For instance, some doses or serving sizes may call for about one or two 24-gram scoops (equivalent to about three tablespoons each) and are commonly packaged in containers sized to contain up to about 0.5 pounds, 1 pound, 2 pounds, 5 pounds, and even 10 pounds of powdered product. It should be evident, then, that transporting and taking supplements when away from home can be a hassle. Indeed, traditional capsule and pill organizers with labeled compartments, are woefully inadequate to contain such volumes of powdered product. In addition to powdered product bulk and weight as compared to pre-dosed pills and capsules, dispensing the correct dosage without appropriate tools or containers can lead to over or under-dosing, which can alter the effectiveness and consistency of the supplement intake. This can also be messy, which can be particularly problematic in environments where cleanliness and hygiene are important.

Some have proposed specialized containers for storing relatively small amounts of powders. U.S. Pat. No. 11,167,910 to Acott describes a container assembly configured to store single servings of powder within a single use, replaceable cartridge. Unfortunately, it is not possible to cater these devices to the individual needs and preferences of their users since they are adapted for use with prepared and sealed single-use cartridges. Likewise, U.S. Pat. Pub. No. 2020/0140135 by Deylamian et al. teaches a container for transporting supplements such as protein powders, however, this does not address the issue of needing to more easily dose and transport multiple servings of supplement powders. Similarly, U.S. Pat. No. 10,433,632 to Resic teaches a shaker bottle having an integrated container for storing a powdered supplement. As above, this does not contemplate the possibility of easily dosing multiple servings of supplement powders to be taken at different times.

Thus, although various proposals have been made to solve the problem(s), none of those in existence combine the characteristics of the present invention. Therefore, there remains a need for a powdered product organizer.

### SUMMARY

The present disclosure is directed to a device and system for dispensing and storing multiple portions of powdered compositions, such as powdered food, ingredients, and nutritional and/or dietary supplements (more generally, “powdered product”) in an organized and accessible manner.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In an embodiment, a system and device for organizing multiple doses of powdered product comprises a base, a vertical support extending upward from the base, a receptacle ring spaced apart from the base by the vertical support, a dispenser platform rotatably seatable over the receptacle ring, a plurality of containers securable to yet removable from the receptacle ring, and a dispenser.

In some embodiments, the receptacle ring is formed as a horizontal disk defining a plurality of circumferentially spaced means for securely, alternately receiving one each of the containers while such containers are being filled via the dispenser.

In one exemplary embodiment, such means may be a plurality of cutouts formed along an outer perimeter of the receptacle ring. In such cases, each cutout may be generally C-shaped, U-shaped, or open-ended, with an opening width sized to allow each container to pass laterally into the slot with a sliding or snapping motion. That is, each cutout may define means for securely, alternately receiving one each of the containers as a “receptacle slot” configured to slidably receive a portion of a corresponding container, such that the container is suspended below the receptacle ring, but above the base, when seated. The cutout geometry may be dimensioned to retain the container by partial radial constraint, such that the container remains suspended during rotation or filling, yet can be removed by lifting or sliding, depending on the specific fit and design.

In some other non-limiting embodiments, such means may be a plurality of circumferentially spaced holes defined by the receptacle ring, each sized to receive a container therethrough. In such cases, each cutout, or receptacle slot, may be substantially circular or tubular, configured to vertically receive and support a container inserted from above. The surrounding structure of the receptacle ring may provide circumferential support, allowing the container to remain suspended in a vertically aligned orientation during filling, while still permitting removal by lifting.

The receptacle slots may optionally include notches, ridges, or frictional features, or the like, to help secure each container against unintended movement or vibration. The containers may rest directly against a surface of the receptacle ring defining each slot or be supported by a shoulder or flange disposed or formed on a portion of the container itself.

Thus one of ordinary skill in the art will recognize that it is contemplated that each container may be removed from a receptacle slot of the receptacle ring as desired to enable efficient transport of dispensed material. Of course, one will also recognize that it is possible that liquids may be dispensed into the containers, although powdered products are referred to throughout this disclosure for the purpose of providing clarifying examples only and not of limiting the claims.

In some embodiments, the containers may comprise bottles, such as, for example only and not limitation, cylindrical bottles sized to contain at least one individual serving of a consumable powdered product, such as a food or nutritional supplement, but which could feasibly be sized and shaped to contain more servings if needed or desired. In some embodiments, the containers may feature a narrowed upper portion (e.g., a neck or spout), a narrowed lower portion (e.g., a tapered or conical base), or both, depending on ergonomic, manufacturing, or dispensing considerations as needed or desired. It will be understood that the particular shape and dimensions of the containers will not limit the invention and provided for example only and not limitation.

Each container may further comprise a cap or stopper operative to maintain powdered products therein. For instance, each container may be configured to securely receive a screw cap, snap fit cap, friction-fit stopper, or any other type of cap, lid, or stopper as needed or desired to maintain the powdered product or other dispensed material or product within such container. In some embodiments, the lid (broadly speaking) may be permanently tethered to the cap or otherwise joined to the container such as with a collar and lead known to those of ordinary skill in the art, in order to prevent loss of such lid.

The dispenser platform is a rotatable component operatively positioned above the receptacle ring and configured to support or define a dispensing mechanism for delivering powdered contents into individual containers. It functions as a rotational interface between the dispenser and the receptacle ring, enabling precise alignment of the dispenser with each container supported by the receptacle ring during filling.

In some embodiments, the dispenser may include or be formed by a funnel structure defined integrally with the dispenser platform, or removably engageable with an opening defined by the platform. The dispenser platform itself is rotatably seatable over the receptacle ring and may be configured to avoid use of or dependence on a central shaft, axle, or other fasteners.

The receptacle ring may define one or more engagement structures configured to mate with corresponding engagement structures disposed on an underside of the dispenser platform. In some embodiments, these engagement structures may be centrally offset from the outer edge of each component, such that they nest, mate, or otherwise engage one another when the dispenser platform is seated on top of the receptacle ring.

In some embodiments, the engagement structures may comprise complementary sinusoidal or undulating edge profiles, which define a series of discrete rotational positions. This interlocking arrangement is configured to resist unintentional rotation while allowing the dispenser platform to be manually rotated and indexed into alignment with each receptacle slot in sequence.

In some embodiments, the engagement structures may additionally or alternatively comprise broad-face mechanical features, such as surface teeth, ridges, or ratchet-like profiles, that enhance stability and tactile feedback during alignment.

The dispenser platform may be manually removable for purposes such as cleaning, refilling, or replacement, and may be repositioned by a simple manual lift and reseat operation. In some embodiments, the dispenser may further comprise features such as a knob or finger grooves to aid manual rotation and removal from its seated position above the receptacle ring.

It is contemplated that providing a funnel as the dispenser will allow a user to hygienically dispense servings of powdered product into each container as desired. The funnel may be removably engagable with the dispenser platform to allow for cleaning. Additionally, the entire dispenser platform, and optionally the receptacle ring, base, and/or vertical support may be configured for washing or sterilization as needed or desired.

In various embodiments, the base, receptacle slots, and/or containers themselves may be labeled or otherwise be configured to receive marks or labels. It is contemplated that this will allow users to easily verify the contents of each container during and after filling, as necessary. Furthermore, it may facilitate the indication and confirmation of the intended consumption date and time for the contents of each container.

In certain embodiments, the organizer may comprise seven slots and containers each to correspond with the days of the week. Alternatively, the device may include a different number of slots or other means for securing the containers to the receptacle ring and/or containers themselves to correspond with specific consumption timings-such as morning, afternoon, and night—as desired or needed.

It is an object of the invention, then, to provide an organizer and dosing system for preparing multiple individual servings of powdered ingredients, such as food and nutritional supplements.

It is another object of the invention to provide low profile, transportable containers adapted for use with individual servings of powdered ingredients, such as food and nutritional supplements.

It is yet another object of the invention that the containers be refillable.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective view of a system for organizing multiple doses of powdered product in accordance with one embodiment.

FIG. 2 shows an exploded view of a system for organizing multiple doses of powdered product in accordance with one embodiment.

FIG. 3 shows an exemplary cross-sectional view of a system for organizing multiple doses of powdered product in accordance with one embodiment.

FIG. 4 illustrates a rotational configuration of a system for organizing multiple doses of powdered product in accordance with one embodiment.

FIGS. 5 and 6 show alternative exemplary embodiments of containers compatible with a device for organizing multiple doses of powdered product in accordance with some embodiments.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by any claims related to this disclosure as may be filed in the future.

Moreover, embodiments and limitations disclosed herein are not dedicated to the public under the doctrine of dedication if the embodiments and/or limitations: (1) are not expressly claimed in any forthcoming claims; and (2) are or are potentially equivalents of express elements and/or limitations in such claims under the doctrine of equivalents.

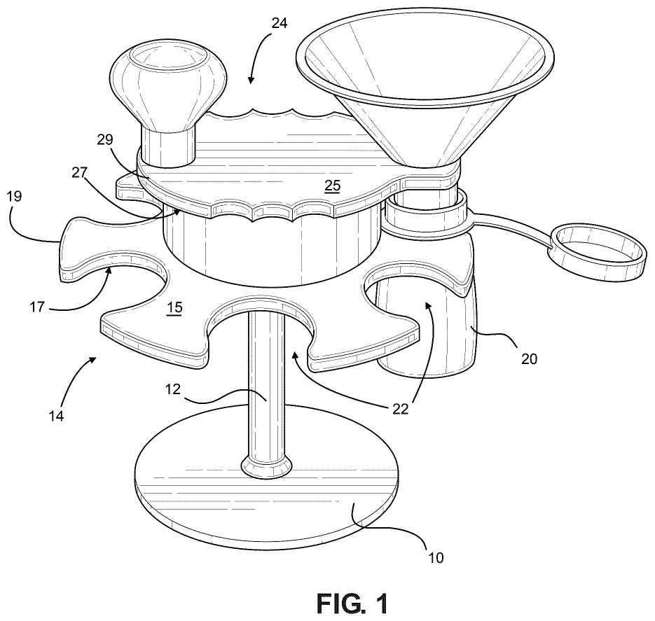

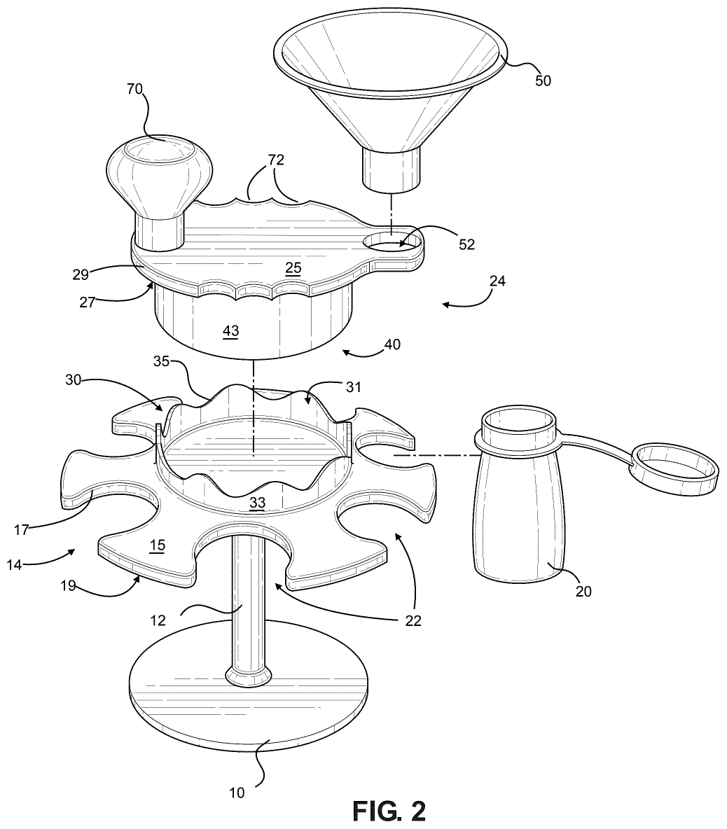

FIGS. 1 and 2 show an exemplary device for organizing multiple doses of powdered product, comprising a base 10; a vertical support 12 extending upward from the base 10; a receptacle ring 14 having a top side 15, a bottom side 17, and a dispenser platform 24.

It may be seen that the receptacle ring 14 is spaced apart from the base 10 by the vertical support 12 and defines a plurality of circumferentially spaced means for securely, alternately receiving and securely suspend individual containers 20 above the base 10 as receptacle slots 22.

The dispenser platform 24, rotatably seatable over the receptacle ring 14, comprises a top side 25, a bottom side 27, and an outer edge 29, and is configured to rotate relative to the receptacle ring 14.

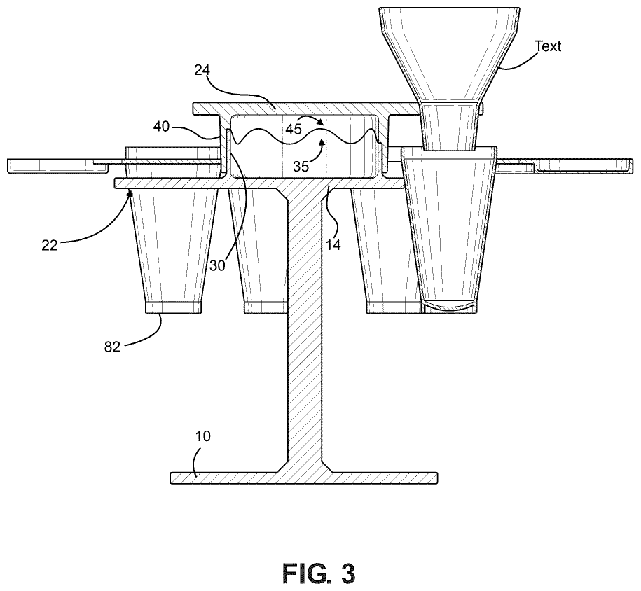

In various embodiments, the base 10, vertical support 12, receptacle ring 14, and/or dispenser platform 24, may be constructed using modular elements that can be assembled and disassembled as needed or desired. In some embodiments, such as that illustrated in FIG. 3, the base 10, vertical support 12, and receptacle ring 14 may be formed as a single molded piece or otherwise constructed by methods known to those of ordinary skill in the art without departing from the invention. For example, the base 10 and vertical support 12 may be integrally formed as a unitary structure, or may comprise separately manufactured components that are joined via fasteners, snap fit elements, or friction fit elements to allow for flexibility in assembly, shipping, or cleaning.

The receptacle ring 14 may be configured to support and organize multiple containers, such as exemplary container 20, for filling. The receptacle ring 14 may be formed as a horizontal disk having a top side 15, a bottom side 17, and an outer edge 19 which, in the exemplary figure, defines a plurality of circumferentially spaced means for securely, alternately receiving and securely suspend individual containers 20 above the base 10 as the receptacle slots 22. In some embodiments, each receptacle slot 22 may be formed as a cutout along the outer perimeter of the receptacle ring 14. These cutouts are shown as C-shaped but may otherwise be formed as U-shaped or open-ended, with an opening width sized to allow lateral insertion of a container. In such embodiments, each receptacle slot 22 is configured to slidably receive a portion of a container, such that the container is suspended below the bottom side 17 of the receptacle ring 14 but above the base 10, allowing for accurate alignment beneath a dispenser. The geometry of each slot 22 may provide partial radial constraint, allowing the container to remain securely suspended during rotation or filling, while still permitting removal by lifting or sliding, depending on the engagement design.

In alternative embodiments, the receptacle ring 14 may define means for securely, alternately receiving and suspending individual containers 20 above the base 10 in the form of circumferentially spaced holes or apertures (not shown but known to those of ordinary skill in the art) configured to vertically receive containers inserted from above. In such cases, each receptacle slot may be substantially circular or tubular and dimensioned to provide circumferential support around the container body. Such container may rest against the slot-defining surface of the receptacle ring 14 or be supported by a shoulder or flange formed on the container itself.

The exemplary receptacle slots 22 or other means for securely, alternately receiving and suspending individual containers 20 above the base 10 may incorporate additional features such as notches, ridges, friction elements, or detents to resist unintentional movement or vibration of the containers during use. This can help maintain proper alignment and reduce the risk of accidental dislodgement during dispensing.

In certain embodiments, the receptacle ring 14 may comprise seven slots to correspond with the days of the week, with a corresponding number of containers comprising the system. Alternatively, the receptacle ring 14 may include a different number of receptacle slots 22 other means for securely, alternately receiving and suspending individual containers 20 above the base 10 correspond with specific consumption timings-such as morning, afternoon, and night—as desired or needed. In any case, the receptacle ring 14 may be configured to aid insertion and removal of each container, enabling users to load, unload, or transport individual containers as needed.

With particular reference to FIG. 2, the receptacle ring 14 may still further comprise an engagement structure 30 extending from the receptacle ring 14 top surface 15 defined by an inside 31, an outside 33 and an engagement edge 35. This structure is configured to cooperate with a complementary engagement structure 40 extending from the bottom side 27 of the dispenser platform 24, which is operatively seatable over the receptacle ring 14 and configured to rotate relative thereto, allowing alignment of a dispenser, such as funnel 50, with individual receptacle slots 22.

In some embodiments, the dispenser platform 24 engagement structure 40 may be concentric with a central axis of the dispenser platform 24 and may be defined by an inner surface (obscured from view in this figure), outer surface 43 and an engagement edge (obscured from view here). The dispenser platform 24 engagement structure 40 is configured to engage with the upward-extending engagement structure 30 of the receptacle ring 14, such that the two structures nest, align, or interface with one another to allow controlled, rotational movement while resisting unintentional displacement.

The engagement edge 35 of the receptacle ring 14 engagement structure 30 and the engagement edge 45 of the dispenser platform 24 engagement structure 40 may define complementary sinusoidal or undulating contours, which provide a series of discrete rotational detents or indexing positions, as shown in the exemplary cross sectional illustration of FIG. 3. These contours are configured to resist unintentional rotation of the dispenser platform 24 relative to the receptacle ring 14 while still permitting the dispenser platform 24 to be manually rotated into alignment with successive receptacle slots 22 or other means for securely, alternately receiving and suspending individual containers 20 above the base 10.

Although the use of complementary sinusoidal contours between the engagement structures provides a smooth, gradual transition between indexed positions, allowing controlled rotation of the dispenser platform with minimal abrupt resistance or snapping, it is contemplated that the engagement structures may be configured in a variety of different manners known to those of ordinary skill in the art without departing from the invention. In some embodiments, for example, the engagement structures may additionally or alternatively comprise broad-face mechanical features, such as surface teeth, ridges, or ratchet-like profiles, that enhance stability and tactile feedback during alignment. As such, it will be recognized that the foregoing is offered by way of example only and not limitation.

Returning to FIG. 2, in some embodiments, the dispenser platform 24 may define an aperture 52, configured to receive or support the funnel 50 or other dispensing component, allowing powdered or flowable product to be directed into any container seated beneath the aligned means for securely, alternately receiving and suspending individual containers 20 above the base 10. The funnel 50 may be permanently affixed to or removably received within the aperture 52 for ease of cleaning and storage.

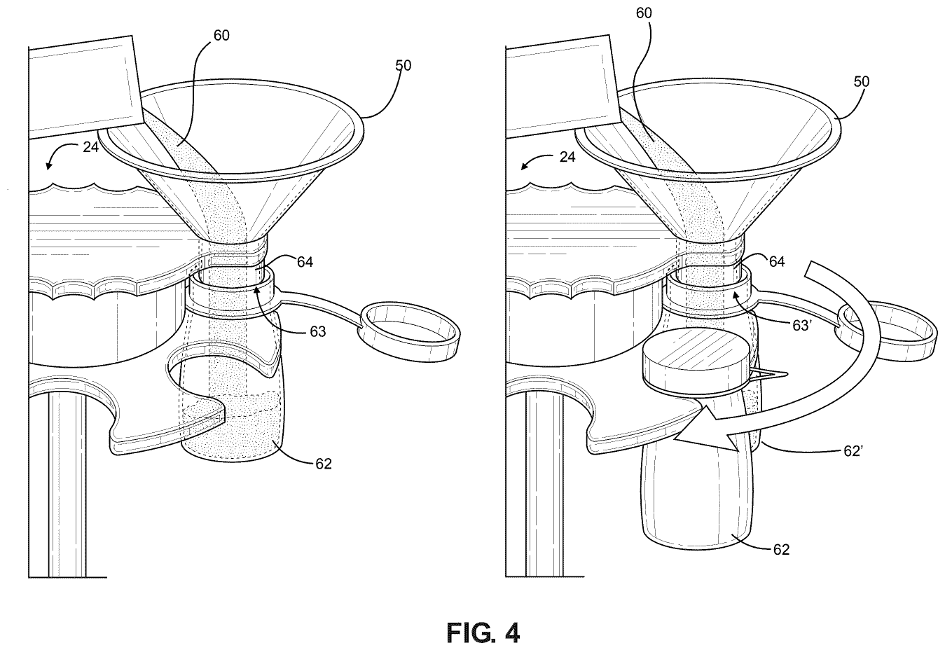

FIG. 4 shows exemplary rotation of the dispenser platform 24 to further illustrate the sequential alignment of the dispenser or funnel 50 with each exemplary receptacle slot 22, enabling controlled dispensing of product 60 into individual containers 62 suspended below the receptacle ring 14. As the dispenser platform 24 is rotated, the exemplary funnel 50 becomes sequentially aligned with each exemplary receptacle slot 22, allowing product 60 to be dispensed into a corresponding container 62, 62′ suspended below. This sequential alignment facilitates accurate, one-at-a-time dispensing of powdered product into individual containers, helping to minimize spillage, cross-contamination, and dosing errors during use.

The device may be configured such that a dispensing end 64 of the funnel 50 or other dispenser extends slightly into a mouth 63, 63′ of the container 62 when aligned, helping to guide the powdered product 60 directly into the container 62 and reduce spillage. It is contemplated that configuration may benefit from or require slight vertical clearance, material flexibility, or flexible positioning to allow the dispenser platform 24 to rotate freely between receptacle slots without interference.

It should also be noted that the engagement structure 40 of the dispenser platform 24 may be configured to fit either snugly or loosely around the engagement structure of the receptacle ring 14 (obscured from view), depending on the desired or necessary balance between rotational resistance and ease of manual alignment or removal without departing from the invention.

To facilitate user manipulation, the dispenser platform 24 may further comprise means for facilitating manual rotation and removal, such as a knob 70 extending from or disposed on the dispenser platform 24 top side 25, as seen in, for example, FIG. 2. As another example, one or more finger grooves 72, or other graspable surface features may be defined by the dispenser platform 24 outer edge 29. These features may allow a user to grip and rotate the platform 24 with minimal effort, enabling precise alignment with each means for securely, alternately receiving and suspending individual containers 20 above the base 10 as needed or desired.

As such, the overall configuration of the dispenser platform 24 and engagement structures 30 (obscured from view), 40 enables accurate rotational indexing, secure engagement during dispensing, and straightforward removal of the platform for cleaning, reloading, or replacement.

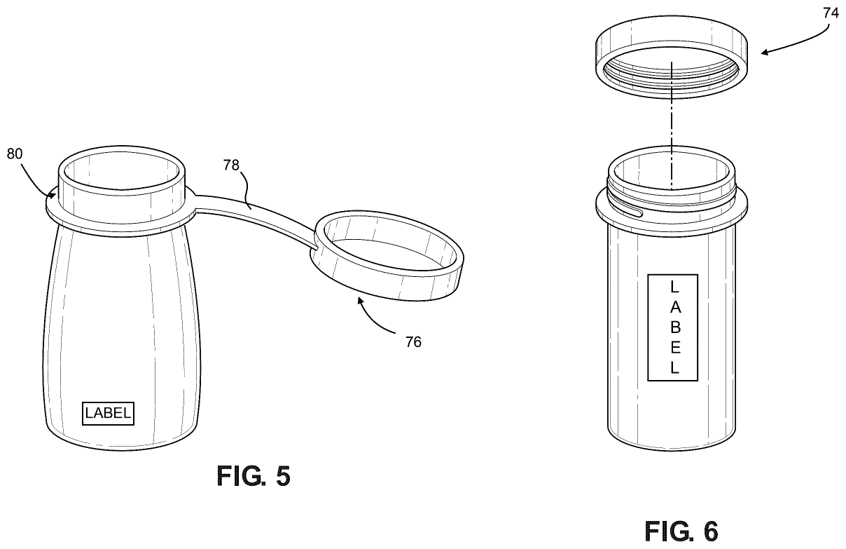

With reference to FIGS. 5 and 6, in various embodiments, the system for organizing multiple doses of powdered product comprises a plurality of individual containers configured to be removably received and securely suspended within receptacle slots or other means for securely, alternately receiving and suspending individual containers above the base as defined by the receptacle ring. The containers may comprise bottles or other vessel forms, and in some embodiments may be cylindrical in shape. Each container may be sized to hold a single dose or serving of powdered product, such as a nutritional or food supplement. However, in alternative embodiments, the containers may be configured to hold multiple servings or variable volumes, depending on user needs or dosing schedules.

Each container may include a closure mechanism such as a cap or lid, which may be removably attachable by a threaded (shown by lid 74 in FIG. 6), snap-fit, or friction-fit (shown by exemplary lid 76 in FIG. 5) interface. In some embodiments, the closure mechanism is tethered to the container by a strap, such as strap 78 in FIG. 5, collar, or hinge to prevent loss during use. The closure mechanism may be configured to provide a substantially airtight seal to preserve the contents and prevent spillage during handling or transport. Of course, one of ordinary skill in the art will appreciate that countless closure mechanisms may be utilized without departing from the invention.

The containers will not be limited by shape. For instance, in some embodiments, such as in FIG. 5, the containers may cylindrical, such as shown in FIG. 6, feature a narrowed upper portion (e.g., a neck 80 or spout), a narrowed lower portion (e.g., a tapered or conical base) such as demonstrated by container 82 in FIG. 3, or any combination of the same or other geometric features, depending on ergonomic, manufacturing, or dispensing considerations as needed or desired. Thus, it will be understood that the particular shape and dimensions of the containers will not limit the invention and provided for example only and not limitation.

Although powdered products are described for ease of reference, the containers may also be used with other flowable materials, including granulated, semi-solid, or liquid substances, depending on the configuration of the dispenser and closure.

In some embodiments, the containers or their associated closure mechanisms may be labeled or otherwise marked for identification, such as to indicate the contents, dosage, or intended time of consumption. This feature may be particularly useful in systems involving multiple doses organized across days or time intervals (e.g., morning, afternoon, evening).

In various embodiments, components of the system may be formed from food-grade materials such as, for example only and not limitation, polypropylene (PP), high-density polyethylene (HDPE), copolyester, glass, aluminum or stainless steel, among others, depending on the intended use, cleaning requirements, and manufacturing method. Elastomeric seals or flexible components may comprise food-grade silicone or thermoplastic polyurethane, while 3D printed components, if used, may be formed from food-safe filaments known to those of ordinary skill in the art.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the container shapes, portion sizes, or arrangement mechanisms may be adapted to suit different types of powdered products or user preferences. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and device for organizing multiple doses of powdered product with which that terminology is associated. In general, the terms used in the following claims should not be constructed to limit the system and device for organizing multiple doses of powdered product to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the System and device for organizing multiple doses of powdered product is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the System and device for organizing multiple doses of powdered product.

What is claimed is:

1. A device for organizing multiple doses of powdered product, comprising:
a base;
a vertical support extending upward from the base;
a receptacle ring having a top side, a bottom side, and an outer edge, the receptacle ring spaced apart from the base by the vertical support and defining a plurality of circumferentially spaced receptacle slots configured to removably receive and securely suspend individual containers above the base;
a dispenser platform having a top side, a bottom side, and an outer edge, the dispenser platform rotatably seatable over the receptacle ring and configured to rotate relative to the receptacle ring.

2. The device of claim 1, wherein the receptacle ring comprises a concentric engagement structure extending upward from the receptacle ring top side and configured to engage a corresponding engagement structure disposed on the dispenser platform bottom side.

3. The device of claim 2, wherein the dispenser platform engagement structure defines a inner surface and an outer surface, the inner surface comprising an engagement edge configured to engage with the upward-extending engagement structure of the receptacle ring to effectuate indexed rotation of the dispenser platform relative to the receptacle ring.

4. The device of claim 3, wherein the engagement edge of the dispense platform and upward-extending receptacle ring engagement structure define complementary sinusoidal contours operative to resist unintentional rotation of the dispenser platform relative to the receptacle ring.

5. The device of claim 3, wherein the receptacle ring and dispenser platform engagement structures are configured and positioned to correspond with the receptacle slots, such that the dispenser platform is selectively, rotatably alignable with each receptacle slot in sequence when the dispenser platform is seated.

6. The device of claim 1, wherein the dispenser platform is removably engageable with the receptacle ring by manual placement and disengagement.

7. The device of claim 1, further comprising means for enabling manual rotation of the dispenser platform relative to the receptacle ring.

8. The device of claim 7, wherein the means for enabling manual rotation of the dispenser platform relative to the receptacle ring comprises a knob extending upward from the dispenser platform.

9. The device of claim 7, wherein the dispenser platform defines one or more concave notches shaped and positioned to receive a user's fingers for manual rotation or removal of the dispenser platform.

10. The device of claim 1, wherein the dispenser platform defines an opening positioned to receive a funnel in alignment with the receptacle rings.

11. A system for organizing and dispensing multiple doses of powdered product, comprising:
a base;
a vertical support extending upward from the base;
a receptacle ring spaced apart from the base by the vertical support and defining a plurality of circumferentially spaced receptacle slots configured to removably receive and securely suspend individual containers above the base;
a dispenser platform rotatably seatable over the receptacle ring and configured to rotate relative to the receptacle ring; and
a dispenser operative to dispense material into a container received in one of the receptacle slots.

12. The system of claim 11, further comprising a plurality of containers, each removably receivable within a receptacle slot of the receptacle ring.

13. The system of claim 11, wherein the dispenser platform defines an opening aligned with the receptacle slots and configured to receive a dispensing end of a funnel and align with each receptacle slot in sequence during rotation of the dispenser platform.

14. The system of claim 11, wherein the dispenser platform comprises a downward-extending engagement structure having an internal edge, and the receptacle ring comprises an upward-extending engagement structure, the internal edge and the upward-extending engagement structure defining complementary sinusoidal contours configured to resist unintentional rotation of the dispenser platform relative to the receptacle ring.

15. The system of claim 11, wherein the engagement structures of the dispenser platform and the receptacle ring are configured and positioned to correspond with the receptacle slots such that the dispenser platform is selectively, rotatably alignable with each receptacle slot in sequence when the dispenser platform is seated over the receptacle ring.

16. The system of claim 11, wherein each container comprises a designated label panel configured to receive a marking and formed on an exterior surface of the container.

17. The system of claim 11, further comprising means for facilitating manual rotation and removal of the dispenser platform from its seated position over the receptacle ring comprising at least one of a knob and one or more finger groves formed along a perimeter of the dispenser platform.
